(19) United States
(12) Patent Application Publication
(10) Pub. No.: US 2016/0093986 A1
(43) Pub. Date: Mar. 31, 2016

(54) CABLE IMPLEMENTING ACTIVE CONNECTOR FOR MODULATING DIFFERENTIAL SIGNALS BY PAM CONFIGURATION

(71) Applicant: Sumitomo Electric Industries, Ltd., Osaka-shi (JP)

(72) Inventor: Yasuhiro MAEDA, Yokohama-shi (JP)

(21) Appl. No.: 14/864,553

(22) Filed: Sep. 24, 2015

(30) Foreign Application Priority Data
Sep. 25, 2014 (JP) 2014-195500

(51) Int. Cl. H01R 13/66

(52) U.S. Cl. CPC H01R 13/665

(57) ABSTRACT

An intelligent cable is disclosed. The cable provides a connector and a metal core. The connector is pluggably coupled with an external apparatus and enclosing a circuit unit electrically connected to an external apparatus. The metal core is electrically connected to the circuit unit in the connector. The circuit unit includes a transmitter and a receiver. The transmitter receives input signals from the external apparatus and outputs a transmitted signal to the metal core. The receiver receives the transmitted signal from the metal core and provides output signals to the external apparatus. A feature of the cable is that the transmitter modulates the input signals and the receiver de-modulates the transmitted signal both by the PAM configuration.

### BACKGROUND OF THE INVENTION

1. Field of the Invention

The present application relates to a cable that implements an active connector for modulating differencial signals by the pulse-amplitude-modulation (RAM) configuration.

2. Background Arts

A Japanese Patent Application laid open No. 2005-135840A has disclosed a cable implementing connectors in respective ends thereof, where the connectors installs circuits to reshape signals to be transmitted and/or received.

Recent electronic systems, such as those connecting servers, storages, and/or switches in a datacenter, often implement a cable provided with active connectors. Conventionally, twisted pair cables, twin-Ax cables, and/or coaxial cables have been widely used for connecting such apparatuses of the servers and so on. Such cables transmit a differential signal output from the apparatus to another apparatus as keeping the configuration of the differential signal by a pair of metal cores constituting the twisted pair cable, the twinax cable, and so on.

An arrangement to transmit the differential signal by a paired cable inevitably requires a huge number of cables as increasing channels on which data are transmitted, which results in a thick cable containing a number of paired cables and degrades the flexibility thereof.

### SUMMARY OF THE INVENTION

An aspect of the present application relates to a cable to transmit data as a transmitted signal. The cable comprises a connector and a metal core. The connector, which is pluggably coupled with an external apparatus, provides a circuit unit electrically connected to a circuit within the external apparatus. The circuit unit includes at least one of a transmitter and a receiver. The transmitter receives input signals and outputs the transmitted signals to the metal core. The receiver receives the transmitted signals from the metal core outputs the output signals to the external apparatus. A feature of the cable of the present application is that the transmitter modulates the input signals by the pulse-amplitude-modulation (PPM) configuration and outputs the modulated signal to the metal core; while, the receiver de-modulates the transmitted signals coming from the metal core by the PAM configuration and outputs the de-modulated signal to the external apparatus as the output signals.

### BRIEF DESCRIPTION OF THE DRAWINGS

The foregoing and other purposes, aspects and advantages will be better understood from the following detailed description of a preferred embodiment of the invention with reference to the drawings, in which:

FIG. 1 schematically illustrates a cable for transmitting data according to an embodiment of the present invention;

FIG. 2 schematically shows a block diagram of a portion of the cable of the first embodiment of the present application;

FIG. 3A schematically shows an eye diagram of an input signal of the cable, and FIG. 3B schematically shows an eye diagram of a transmitted signal of the cable, which is modulated by the pulse amplitude modulation (PAM) configuration;

FIG. 4 shows a side cross section of a connector of an embodiment of the present invention;

FIG. 5A schematically shows an arrangement of a top surface of a circuit board of the present embodiment, and FIG. 5B schematically shows a back surface of the circuit board;

FIG. 6A schematically shows another arrangement of the top surface of the circuit board, and FIG. 6B schematically shows another arrangement of the back surface of the circuit board;

FIG. 7A schematically shows still another arrangement of the top surface of the circuit board, and FIG. 7B schematically shows still another arrangement of the back surface of the circuit board;

FIG. 8A schematically shows still another arrangement of the top surface of the circuit board, and FIG. 8B shows still another arrangement of the back surface of the circuit board;

FIG. 9 schematically illustrates a block diagram of a portion of the cable according to the second embodiment of the present application;

FIG. 10A schematically shows an arrangement of the top surface of the circuit board of the cable shown in FIG. 9, and FIG. 10B schematically shows an arrangement of the back surface of the circuit board of the embodiment; and

FIG. 11A schematically shows another arrangement of the top surface of the circuit board of the cable shown in FIG. 9; and FIG. 11B schematically shows another arrangement of the back surface of the circuit board.

### DESCRIPTION OF EMBODIMENTS

Some embodiments of the present application will be described as referring to drawings. However, it is intended that the present invention is not limited to those particular embodiments and modification explicitly disclosed herein, but the invention include all embodiments falling within the scope of the appended claims. In the description of the drawings, numerals or symbols same with or similar to each other will refer to elements same with or similar to each other without duplicated explanations.

### First Embodiment

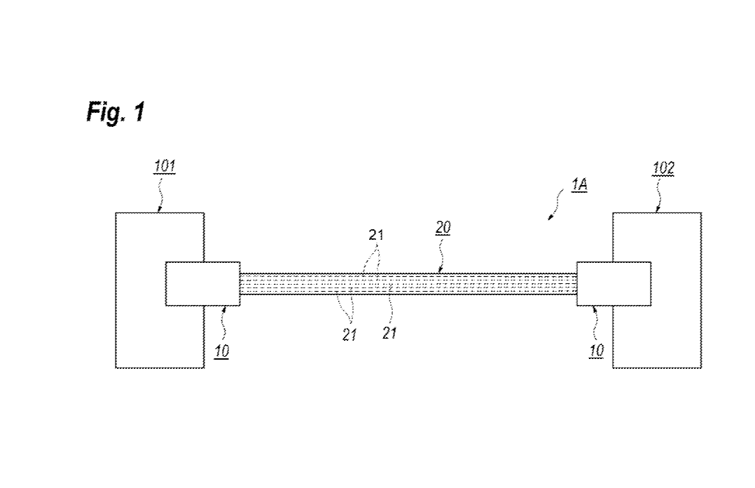

FIG. 1 schematically illustrates a cable 1A according to an embodiment of the present invention. As shown in FIG. 1, the cable 1A comprises a cable bundle 20 and two connectors 10 each attached to respective ends of the cable bundle 20. The cable bundle 20 includes a plurality of coaxial cables 21. One of connectors 10 is to be plugged with an external apparatus 101 and electrically connected thereto. The other connector 10′ is also no be plugged with other external apparatus 102 to constitute the electrical connection thereto. The description below concentrates on an arrangement that the cables within the cable bundle 20 are the type of the coaxial cable. However, the bundle cable 20 may include, for instance, a type of the twin-Ax cable and/or the twisted pair cable.

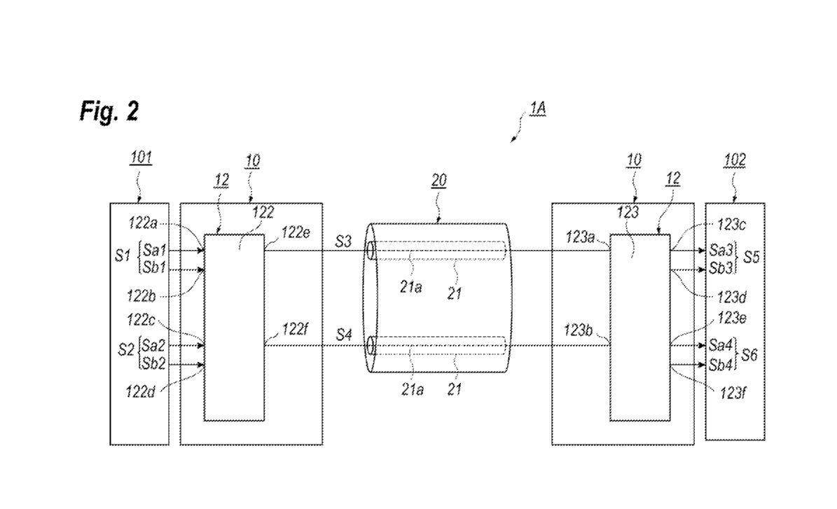

FIG. 2 schematically shows a functional block diagram of the cable 1A. Two connectors 10 each provides a circuit unit 12, which may include a signal shaper such as a clock data recovery (CDR), a repeater, and so on, with a type of an integrated circuit (IC) 121. The circuit unit 12 in one of the connectors 10 is electrically connected to the external apparatus 101 by plugging the connector 10 with the external apparatus 101, and the circuit unit 12 in the other of the connectors 10 is also coupled with the external apparatus 102 by plugging the other connector 10 with the external apparatus 102.

The circuit unit 12 includes a transmitter 122 and a receiver 123. The embodiment shown in FIG. 2 has an arrangement that the circuit unit 12 in the one of the connectors 10 provides only the transmitter 122 and the other circuit unit 12 in the other of the connectors 10 includes only the receiver 123 for the explanation sake. However, the circuit unis 12 in respective connectors 10 may provide both the transmitter 122 and the receiver 123.

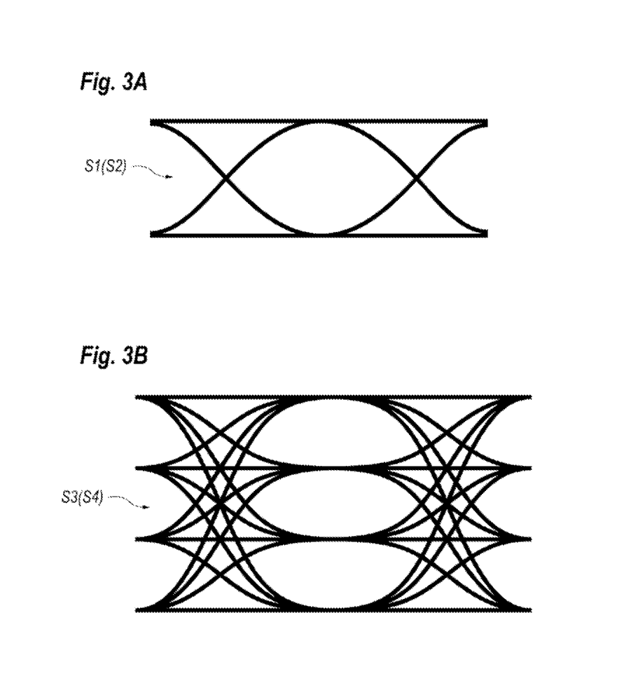

The transmitter 122 receives an input signal S1 in a pair of input terminals, 121a and 121b, and another input signal S2 in another pair of input terminals, 121c and 121d. The input signals, S1 and S2 have a configuration of a differential signal including positive phase signals, Sa1 and Ss2, and negating phase signals, Sb1 and Sb2. The input signals, S1 and S2, constitute the signal channels. FIG. 3A schematically illustrates an eye diagram of the differential, signal. The input signals, S1 and S2, which enters the transmitter 122, have a type of the NRZ (Non-Return to Zero) signal attributed to two logic levels of HIGH(1) and LOW(0) by an amplitude therebetween. Thus, the input signals, S1 and S2, each contain information corresponding to one (1) bit because of two logic levels.

The transmitter 122 reshapes the input signals, S1 and S2, to output the transmitted signals, S3 and S4. Specifically, the transmitter 122 multiplexes the positive phase signals and the negative phase signals of the input signals, S1 and S2. Accordingly, the transmitted signals, S3 and 34, become amplitude multiplexing signal having greater multiplicity compared with the input signals, S1 and S2. The transmitted signal S3 multiplexes the positive phase signals, Sa1 and Sa2, while, the other transmitted signal S4 multiplexes the negative phase signals, Sb1 and Sb2. Thus, the transmitted signals, S3 and S4, constitute a differential configuration. FIG. 3B snows an example of an eye diagram of the transmitted signals, S3 and S4. As shown in FIG. 3B, the transmitted signals, S3 and S4, are a type of the PAM-4 (4-level Pulsed Amplitude Modulation) configuration having four (4) logic levels. That is, the lowest level corresponds to a condition where both of the input signals, S1 and S2, become LOW level, next lower level corresponds to a second condition where the input signal S1 becomes HIGH but the other input signal S2 is set LOW, the next level corresponds to a third condition where the input signal S1 is set LOW but the other input, signal S2 becomes HIGH, and the highest level corresponds to a fourth condition where both input signals, S1 and S2, become HIGH. Accordingly, the transmitted signals, S3 and S4, constituting the differential arrangement contain information corresponding to two (2) bits.

The transmitted signals, S3 and S4, are output to the output terminals, 122e and 122f, where former terminal 122e is electrically connected to a metal core 21a of one of the coaxial cables in the cable bundle 20, while, the other output terminal 122f is connected to a metal core 21a of another of the coaxial cables in the cable bundle 20. These coaxial cables 21 are coupled with the connector 10 of the receiver 123. The receiver 123 provides a pair of input terminals, 123a and 123b, the former of which is connected to the output terminal 122e of the transmitter 122 through the metal core 21a, while, the latter 123b is connected to the output terminal 122f through the metal core 21a of the another coaxial cable.

The receiver 123 outputs an output signal S5 from a pair of output terminals, 123c and 123d, and another output signal S6 from another pair of output terminals, 123e and 123f. That is, the receiver 123 demodulates the transmitted signals, S3 and S4, to recover the output signals, S5 and S6, where the former output signal S5 is a differential signal containing a positive phase signals Sa3 and a negative phase signal Sb3, while, the latter output signal S6 is also a differential signal containing another positive phase signal Sa4 and another negative phase signal Sb4. Thus, the output signals, S5 and S6, each correspond to the input signals, S1 and S2. The output signals, S5 and S6, are provided to an external apparatus 102.

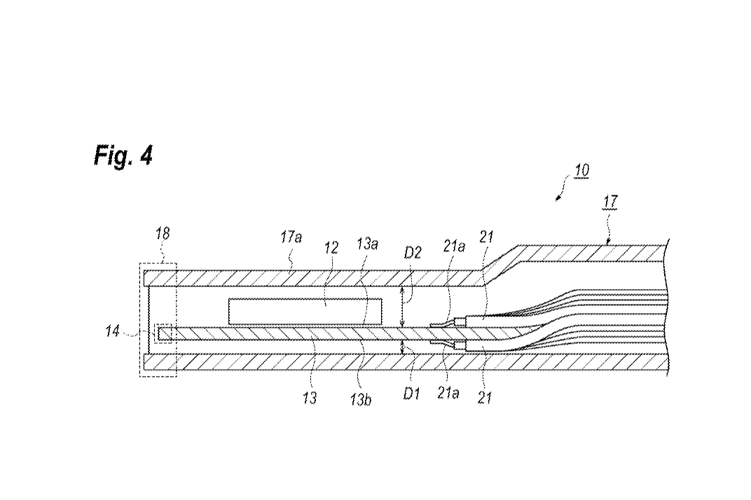

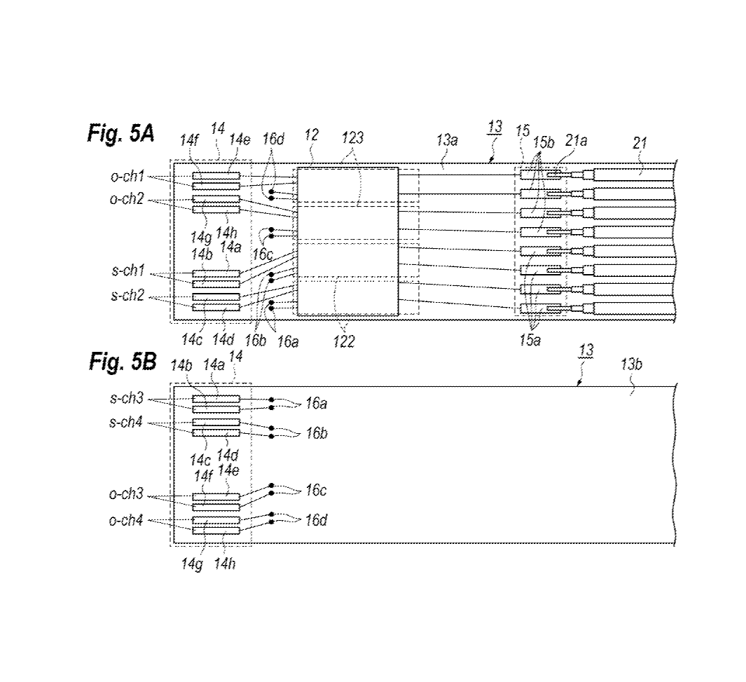

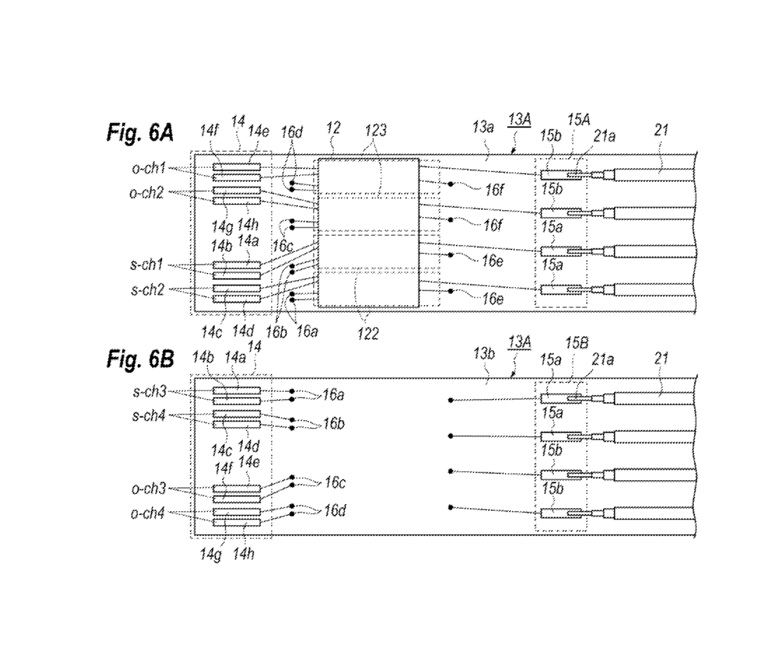

FIG. 4 shows a cross section and FIG. 6 shows a plan view of the connector 10 of the present embodiment, where FIG. 5A shows a top surface 13a of the circuit board 13 and FIG. 5B shows a back surface 13b of the circuit board 13. The connector 10 of the present embodiment provides the circuit board 13, which has a rectangular plane shape, including a ceramic, substrate and interconnections formed on top and back surfaces of the ceramic substrate. The circuit board 13 provides an area for mounting the circuit units 12 thereon, an interface 14 electrically connected to the circuit unit 12 and another interface 15 coupled with the coaxial cables 21. In the present embodiment shown in FIGS. 5A to 6B, the area for mounting the circuit unit 12 is provided in only the top surface 13a of the circuit board 13. The circuit unit 12 includes two transmitters 122 and two receivers 123 to receive four signals, s-ch1 to s-ch4, and output other four signals, O-ch1 to O-ch4. These signals, s-ch1 to s-ch4 and O-ch1 to O-ch4, are differential signals. Some of four signals, s-ch1 to s-ch4, may be same as the input signals, S1 and S2.

The interface 14 includes a plurality of terminals, 14a to 14b. Specifically, the top and back surfaces, 13a and 13b, of the circuit board 13 each provide the four paired terminals, 14a and 14b, 14c and 14d, 14e and 14f, and 14g and 14h. The former four terminals, 14a to 14d, are provided in a side where the transmitters 122 are mounted, while, the latter four terminals, 14e to 14h, are provided in another side where the receivers 123 are mounted.

In the top surface 13a of the circuit board, the first pair of terminals, 14a and 14b, and the second pair of the terminals, 14c and 14d, receive the input signals, s-ch1 and s-ch2. In the back surface 13b of the circuit board 13, the first pair of the terminals, 14a and 14b, and the second pair of the terminals, 14c and 14d, receive the input signals, s-ch3 and s-ch4, respectively but couple with the transmitters 122 in the top surface 13a of the circuit board 13 through via holes, 16a and 16b. Two pairs of terminals, 14e and 14f, and 14g and 14h, in the top surface 13a are coupled with the receivers 123 and output the output signals, o-ch1 and o-ch2. Also, rest two pairs of terminals, 14e and 14f, and 14g and 14h, in the back surface 13b are coupled with the receivers 123 on the top surface 13a through respective via holes, 16c and 16d, and output the output signals, o-ch3 and o-ch4. Thus, the terminals formed in the back surface 13b of the circuit board 13 may be electrically coupled with the circuit unit 12 in the top surface 13a through respective via holes, 16a to 16d. As described above, the circuit unit 12 provides two transmitters 122 which collectively have four input terminals and two output terminals. One of the transmitters 122 receives two input signals, s-ch1 and s-ch3, and generates one transmitted signal in the output terminal thereof. The other transmitter 122 receives two input signals, s-ch2 and s-ch4, and generates one transmitted signal in the output terminals thereof.

Terminals, 14e to 14h, in the top and back surfaces, 13a and 13b, of the circuit board 13 are provided for out putting signals and connected to output terminals of the receiver 123 such as terminals 123c to 123f shown in FIG. 2. The terminals, 14e to 14h, output the output signals, o-ch1 to o-ch4, each having the differential configuration. Specifically, the terminals, 14e and 14f, in the top surface 13a output the output signals o-ch1 and the terminals, 14g and 14h, also provided in the top surface 13a output the output signals o-ch2. The terminals, 14e and 14f, in the back surface 13b of the circuit board 13 output the output signals o-ch3, and the terminals, 14g and 14h, also provided in the back surface 13b output the output signals o-ch4. The terminals, 14e and 14h, in the back surface 13b are connected to one of the receivers 123 through the via holes 16c, while, the terminals, 14g and 14h, in the back surface 13b are connected to the other of the receivers 123 through the via holes 16d. Thus, the terminals, 14e to 14h, in the back surface 13b couple with the receiver 123 implemented on the top surface 13a of the circuit board 13. The receivers 123 in the circuit unit 12 each provide two input terminals and four output terminals. One of the receivers 123 generates the two output signals, o-ch1 and o-ch3, each having the differential arrangement by receiving one transmitted signal with the differential arrangement. Similarly, the other receiver 123 also generates the two output signals, o-ch2 and o-ch4, each having the differential arrangement by receiving one transmitted signal with the differential arrangement.

The interface 15 includes four pads 15a and other four pads 15b both provided in the top surface 13a. These pads, 15a and 15b, are connected to respective metal cores 21a of the coaxial cables 21. The coaxial cables 21 are provided only in the side of the top surface 13a of the circuit board 13. The pads, 15a and 15b, have a width 1.1 to 3.0 times greater than a diameter of the metal core 21a, preferably, 1.2 to 2.0 times greater than the diameter of the metal core 21a. The pads, 15a and 15b, preferably has a span to the neighbors greater than the width thereof. The pads 15a are provided for transmitting the transmitted signals. Specifically, four pads 15a are connected at least in the AC mode to the output terminals of the transmitter 122. The other four pads 15b are provided for receiving the transmitted signals and connected at least in the AC mode to the input terminals of the receiver 123.

The connector 10 further provides a housing 17 that encloses the circuit unit 12 and the circuit board 13. The housing 17 has a box shape extending along a longitudinal direction of the circuit board 13. The housing 17 provides a lid 17a facing the top surface 13a of the circuit board 13 and a bottom 17b facing the back surface 13b of the circuit board 13. A front of the housing 17 has an opening that forms an electrical connector 18 accompanying with the terminals 14. A rear of the housing 17 outputs the coaxial cables 21. In the present embodiment, a space D1 between the back surface 13b of the circuit board 13 and the bottom 17b of the housing is narrower than a space D2 between the top surface 13a of the circuit board 13 and the lid 17a.

Advantages of the cable 1A of the present embodiment will be described. The data transmission between external apparatuses, 101 and 102, are performed by the differential signal. The cable 1A of the embodiment receives the differential signals, S1 and S2, from the external apparatus, 101 or 102, and the transmitter in the cable 1A modulates the differential signals, S1 and S2, by the PAM configuration to generate the transmitted signals, S3 and S4, with the type of the differential signal, and output the transmitted signals, S3 and S4, to the metal cores 21a. This arrangement may reduce a number of the metal cores 21a within the cable 1A. Thus, the cable 1A may be formed in thin and flexible enough even the cable 1A includes a large number of metal cores 21a. Also, even when the metal cores 21a are formed in thick to reduce the transmission loss, the flexibility of the cable 1A may be maintained. The reduction of the number of the metal cores 21a may enhance the productivity or the soldering or the metal cores 21a to the pads, 15a and 15b, on the circuit board 13.

Also, the transmitter 122 provides a pair of output terminals, 122e and 122f, and the receiver 123 provides a pair of input terminals, 123a and 123b. The output terminals, 122e and 122f, may output a transmitted signal having the differential arrangement, and the input terminals, 123a and 123b, may receive a transmitter signal having the differential arrangement.

Only one of the surfaces 13a of the circuit board 13 may provide the pads, 15a and 15b. The coaxial cables 21 are soldered to the pads provided only in one of the surfaces, which may simplify the process to assemble the cable 1A. One type of conventional modules, which is often called as QSFP (Quadrature Small Form factor Pluggable) module, arranges the coaxial cables in both surfaces of the circuit board, which makes hard to assemble electronic components in respective sides of the circuit board when the circuit board is arranged offset from a center of the housing 17, that is, a distance D2 between the back surface 13b of the circuit board 13 to an inner surface of the housing 17 is set narrower than a distance D1 between the top surface 13a to another inner surface of the housing 17. Even when the circuit board 17 is so arranged, the coaxial cables 21 may be soldered only to the top surface 13a of the circuit board 13. Also, the circuit board 13 may mount all the circuit units 12 only on the top surface 13a thereof. This arrangement may simplify the process to mount the circuit units 12 on the circuit board 13 and may leave a space in the back surface 13b for mounting other electronic components thereon.

### First Modification

FIG. 6A schematically illustrates a top view of the circuit board 13A modified from the circuit board 13 of the first embodiment, and FIG. 6B illustrates a back surface of the circuit board 13B. The circuit board 13A provides, substituted from the interface 15 of the first embodiment, interfaces, 15A and 15B, mounted on the top surface 13a and the back surface 13b, respectively. The interface 15A in the top surface 13a provides two pads 15a of the transmission and other two pads 15b for the reception. The other interface 15B in the back surface 13b also provides two pads 15a for the transmission and other two pads 15b for the reception.

The pads 15a are electrically connected to the output terminals 122e of the transmitter 122 in the AC mode through interconnections on the top surface 13a, and the other pads 15a in the hack surface 13b are electrically connected to the transmitter 122 in the top surface 13a in the AC mode through respective via holes 163 and the interconnections. The pads 15b in the top surface 13a are connected to the input terminals 123a of the receiver 123 through the interconnections in the AC mode, and the other pads 15b in the back surface 13b are connected to the input terminals 123a of the receiver 123 in the top surface 13a through the interconnections and the via holes 16f.

Because the pads, 15a and 15b, are provided in respective surfaces, 13a and 13b, the arrangement may expand spans between the pads, 13a and 13b, and between the metal cores 21, which may effectively reduce the crosstalk between the interconnections and the metal cores 21a. Also, the process to solder the metal cores 21a to the pads, 15a and 15b, may be simplified. Two types of the crosstalk may be taken into account, one type is the crosstalk between the input signals, the transmitted signals, and/or the output signals, and the other type is the crosstalk between the input signals and the transmitted signals, and between the transmitted signals and the output signals. The former type of the crosstalk is often called as the far end crosstalk (FEXT), while, the latter is called as the near end crosstalk (NEXT). The arrangement of the present modification may reduce both types of the crosstalk.

### Second Modification

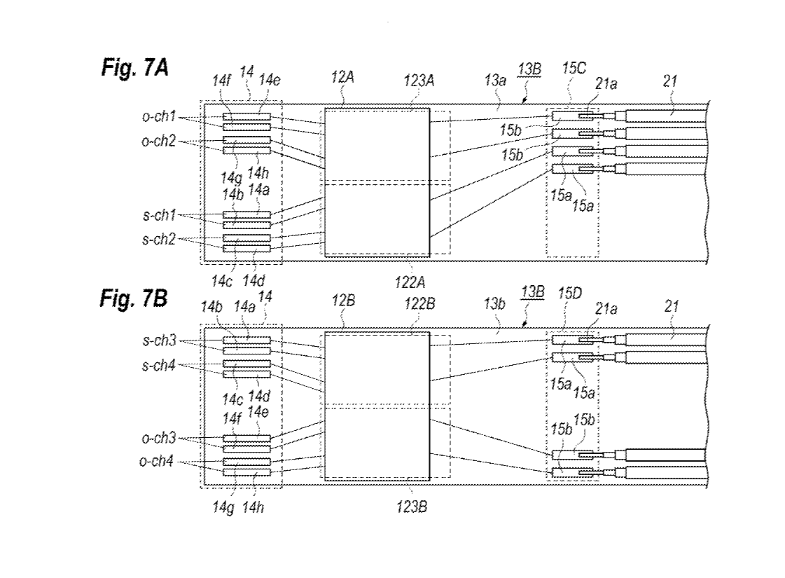

FIG. 7A schematically illustrates a plan view of the top surface 13a of the circuit board 13B and FIG. 7B illustrates the back surface 13b thereof modified from those shown in FIGS. 6A and 6B, respectively.

The circuit board 13B provides the circuit units, 12A and 12B, where the former is mounted on the top surface 13a and the latter is mounted on the back surface 13b of the circuit board 13B. The former circuit unit 12A includes both the transmitter 122A and the receiver 123A, and the latter circuit unit 12B includes both the transmitter 122B and the receiver 123B. The transmitter 122A in the top surface 13a is coupled with the terminals, 14a to 14d, in the top surface 13a, and the receiver 123A in the top surface 13a is coupled with the terminals, 14e to 14h in the top surface 13a. The transmitter 122B in the back surface 13b is coupled with the terminals, 14a to 14d, in the hack surface 13b and the receiver 123B in the back surface 13b is coupled with the terminals, 14e to 14h, in the back surface 13b.

Also, the circuit board 13B of the present modification provides the interfaces, 15C and 15D, where the former interface 15C is provided in the top surface 13a and the latter interface 15D is provided in the back surface 13b. The interface 15C in the top surface 13a includes two pads 15a coupled to the transmitter 122A through the interconnections and other two pads 15b coupled to the receiver 123A through the interconnections, where both interconnections are provided in the top surface 13a. The other interface 15D in the back surface 13b provides two pads 15a coupled to the transmitter 122B through the interconnections and other two pads 15b coupled to the receiver 123B through the interconnections. The pads, 15a and 15b, in the top surface 13a are arranged in one side of the circuit board 13a to leave a space in the other side, while, the pads, 15a and 15b, in the back surface 13b are arranged only in respective sides of the circuit board 13 to leave a space in a center of the circuit board 13. The spans between pads, 15a and 15b, in the top surface 13a and the bottom surface 13b, are set to be narrower than the spans between pads, 15a and 15b, in the aforementioned medication shown in FIGS. 7A and 7B.

The circuit board 13B of the present modification provides the circuit units, 12A and 12B, each including the transmitters, 122A and 122B, and the receivers, 123A and 123B, respectively; but, the circuit board 13B has no via holes, which may reduce a cost of the circuit board 13B. The arrangement of the pads, 15a and 15b, of the present modification may leave a space in another side of the top surface 13a and in a center of the back surface 13b, where additional electrical components may be mounted in those spaces.

### Third Modification

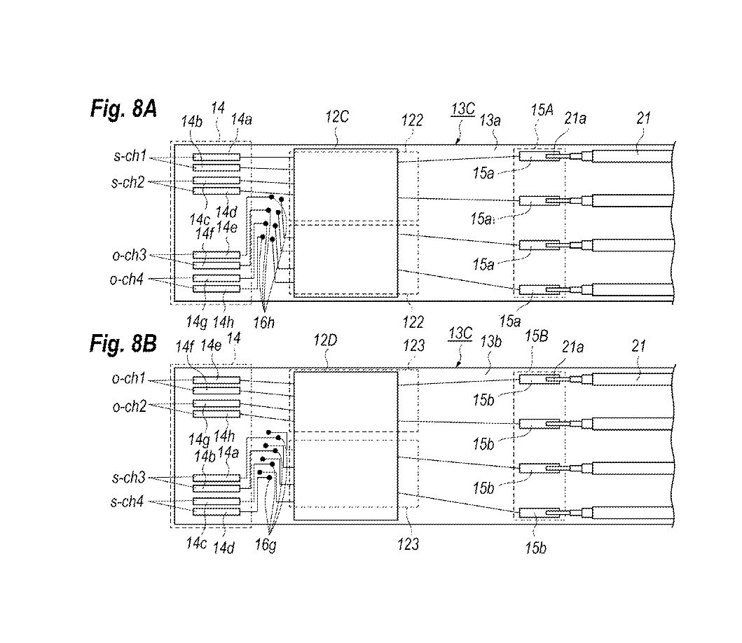

FIGS. 8A and 8B schematically illustrate a plan view of the top surface 13a and the back surface 13b of the circuit board 13C according to the third modification of the aforementioned circuit board 13 shown in FIGS. 6A and 6B.

The circuit board 13C of the present modification provides the circuit units, 12C and 12D, instead of the circuit units, 12A and 12B, of the former modification shown in FIGS. 7A and 7B. The circuit unit 12C, which is provided on the top surface 13a , includes two transmitters 122, one of which is coupled with the terminals, 14a to 14d, in the top surface 13a through the interconnections and the other is coupled with the terminals, 14a to 14d, provided in the back surface 13b through the via holes 16g and the interconnections. The other circuit unit 12D, which is provided in the back surface 13b, includes two receivers 123, one of which is coupled with the terminals, 14e to 14h, in the back surface 13b through the interconnections, and the other is coupled with the terminals, 14e to 14h, in the top surface 13a through the via holes 16h and the interconnections. The circuit board 13C also provides the interfaces, 15A and 15B, in the top and back surfaces, 13a and 13b, respectively.

The circuit board 13C provides the transmitters 122 only in the top surface 13a thereof but the receivers 123 only in the back surface 13b thereof. That is, the circuit board 13C electrically isolates the receivers 123 from the transmitters 122 by the circuit board 13C, which may effectively reduce the near end crosstalk (NEXT).

### Second Embodiment

Next, a cable for transmitting data according to the second embodiment of the present application will be described. Descriptions herein below will concentrate on portions distinguishable from those of the first embodiment. That is, arrangements in the first embodiment may be applicable to the second embodiment within technically available ranges.

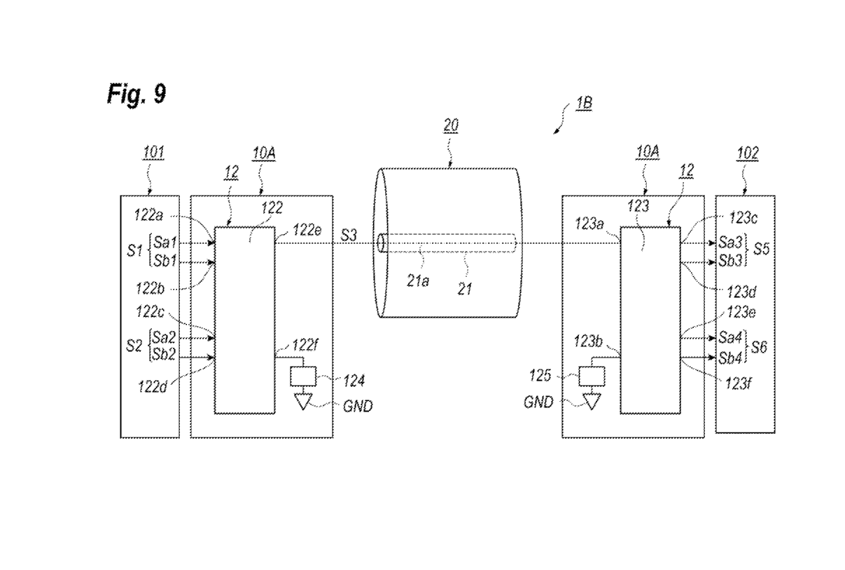

FIG. 9 schematically illustrates a functional block diagram of the cable 1B for transmitting data. As illustrated in FIG. 9, the cable 1B in one of the connector 10A thereof provides a terminator 124 connected to the transmitter 122. The terminator 124, which may include a resistor with resistance of 50 Ω and a capacitor connected in parallel to the resistor, is connected between one of the output terminals, 122e and 122f, of the transmitter 122 and the ground GWD, or a the power supply line.

One of the transmitted signal, S3 or S4, generated in the transmitter 122 is terminated by the terminator 124, where FIG. 9 snows an example that the output terminal 122f to output the transmitted signal S4 is terminated. The other transmitted signal S3 is output to the metal core 21a of the coaxial cable 21. As described, the transmitted signal S3 is one of the positive phase signal and the negative phase signal of the differential arrangement, that modulates the input signal S1 and the other input signal S2 by the PAM configuration. That is, the transmitted signal S3 transmitted on the metal core 21a is the single-ended signal.

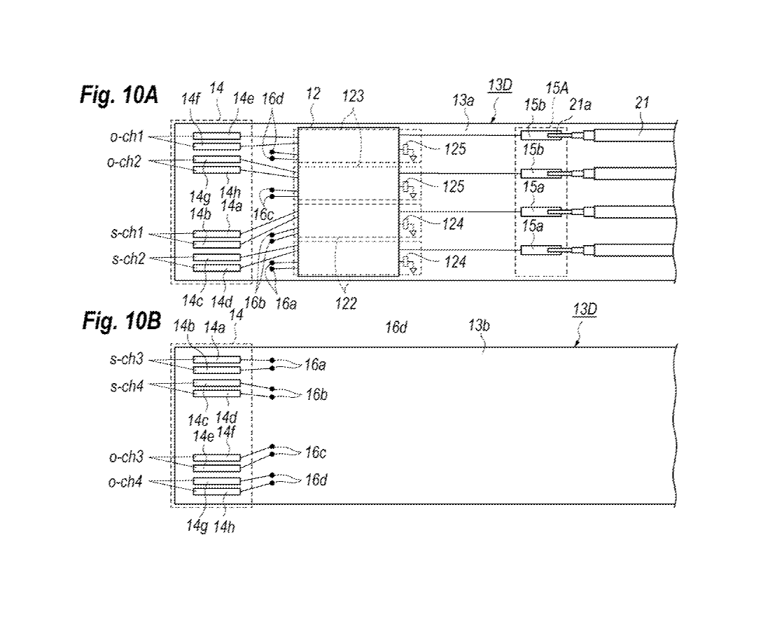

The cable 1B further provides the other connector 10A also providing a terminator 125 connected to the circuit unit 12. That is, one of the input terminals, 123a and 123b, of the receiver 123 is terminated to the ground GND by the terminator 125. In FIG. 9, the input, terminal 123b is terminated. The terminator 125 may be terminated to a power supply line and so on inherently showing low impedance. The receiver 123 de-modulates the input signal S3, which comes from the metal core 21b and has the single-ended configuration, to the output signals, S5 and S6, and outputs these signals, S5 and S6, to the external apparatus as respective differential signals. FIG. 10A schematically shows a plan view of the top surface 13a of the circuit board 13D, and FIG. 10B is a plan view of the back surface 13b thereof. The top surface 13a provides the interface 15A that includes the pads, 15a and 15b, but the back surface 13b thereof provides no pads.

The cable 1B of the second embodiment may reduce the number of the metal cores 21a, compared with that, of the first embodiment, by transmitting the transmitted signals output from the transmitter 122 by the single-ended configuration, which brings that the pads, 15a and 15b, in the connectors 10A may widen the spans therebetween, and accordingly simplify the process to solder oho metal cores 21a to the pads, 15a and 15b.

### Third Embodiment

Next, another cable for transmitting data according to the third embodiment of the present application will be described. The description below omits explanations for the elements and arrangements same with or similar to those of the aforementioned embodiment, and concentrates on portions distinguishable from those of the first and second embodiments. Descriptions for the first and second embodiments may be applicable to the third embodiment within their technically available ranges.

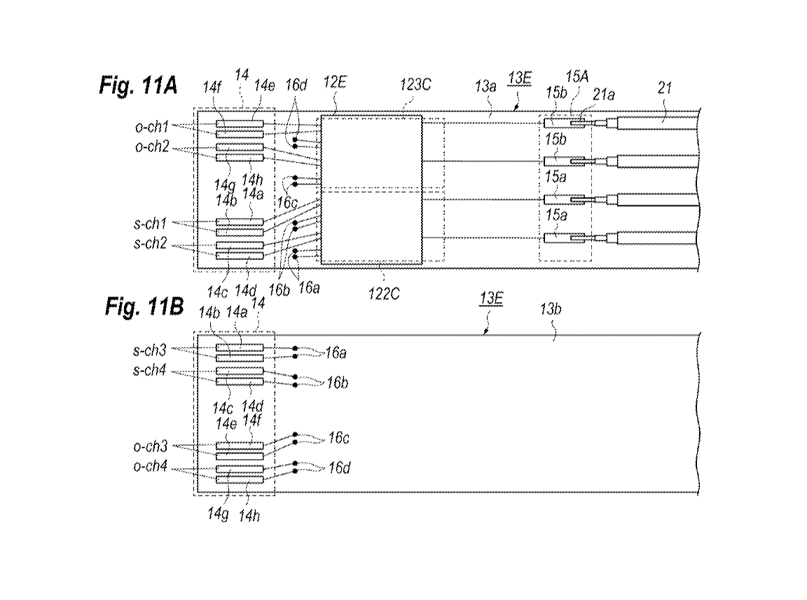

FIG. 11A is a plan view of the top surface 13a of the circuit board 13E according to the present embodiment, while, FIG. 11B is a plan view of the back surface 13b thereof. The connector 10A provides the circuit unit 12E only in the top surface 13a of the circuit board 13E, where the circuit unit 12E includes both the transmitter 122C and the receiver 123C.

The transmitter 122C modulates the input signals, s-ch1 to s-ch4, into one PAM signal with the differential arrangement containing tow signals, S3A and S4A. Accordingly, the transmitter 122C provides eight (8) input terminals and two (2) output-terminals for outputting the differential transmitted signals, S3A and S4A. That is, the differential signal, S3A and S4A, has the PAM-16 configuration and includes the information expressed by four (4) bits.

The receiver 123C de-modulates the transmitted signal with the differential arrangement and having the PAM-16 configuration to generate four (4) output signals, o-ch1 to o-ch4, Accordingly, the receiver 123C provides two input (2) terminals and eight (8) output terminals. The cable according to the third embodiment may show the functions and advantages similar to and same with those of the aforementioned cables, 1A and 1B. Also, the cable according to the third embodiment transmits the transmitted signal by the differential configuration but, enhances the modulation degree thereof, which reduces the number of the metal cores 21a in the cable.

The cable for transmitting data according to the present invention is not restricted to those described above. Various modifications may be applicable. For instance, the connectors provided in respective ends of the cable may implement both the transmitter and the receiver, where a portion of the metal cores 21a is connected between the transmitter in one connection and the receiver in the other connector, and a rest portion of the metal cores is connector between the receiver in the one connector and the transmitter in the other connector. Thus, such a cable realizes the full-duplex communication. Also, the second embodiment of the present invention terminates one of the output terminals of the transmitter and one of the input terminals of the receiver to transmit the transmitted signals as the single-ended signal. However, various techniques except for those described above may be applicable to convert the differential signal to the single-ended signal and the single-ended signal to the differential signal. Therefore, it is intended that the present invention not be limited to the particular embodiments disclosed, but that the invention include all embodiments failing within the scope of the appended claims.

I claim:

1. A cable for transmitting a transmitted signal, comprising:
a connector to be pluggably coupled with an external apparatus, the connector providing a circuit unit electrically connected to a circuit in the external apparatus, the circuit unit including at least one of a transmitter and a receiver, the transmitter receiving input signals and outputting the transmitted signals, the receiver receiving the transmitted signal and outputting output signals to the external apparatus; and
a metal core connected to the circuit unit,
wherein the circuit unit modulates the input signals by a pulse amplitude modulation (PAM) and outputs the modulated signal to the metal core as the transmitted signal, and
wherein the circuit unit de-modulates the transmitted signals from the metal core by the PAM and outputs the de-modulated signal to the external apparatus as the output signals.

2. The cable of claim 1,
wherein the transmitter provides a pair of output terminals for outputting the transmitted signal as a differential arrangement; and
wherein the receiver provides a pair of input terminals for receiving the transmitted signal as the differential arrangement.

3. The cable of claim 2,
wherein the transmitted signal is a single-ended arrangement,
wherein the transmitter terminates one of the paired output terminals and transmits the transmitted signal from another of the paired output terminals to the metal core in an AC mode, and
wherein the receiver terminates one of the paired input terminals and receives the transmitted signal from another of the paired input terminals from the metal core in the AC mode.

4. The cable of claim 1,
wherein the connector further provides a circuit board that includes,
an area for mounting the circuit unit,
an interface electrically coupled with the external apparatus and the circuit unit, and
another interface that includes a pad electrically connected to the circuit unit and attaching the metal core thereto.

5. The cable of claim 4,
wherein she circuit board mounts a portion of the circuit unit in a top surface thereof and a rest portion of the circuit unit in a back surface thereof.

6. The cable of claim 5,
wherein the circuit unit includes a plurality of transmitters mounted on the top surface of the circuit board and a plurality of receivers mounted on the back surface of the circuit board.

7. The cable of claim 4,
wherein the circuit unit includes a plurality of transmitters and a plurality of receivers, and
wherein the top surface of the circuit board mounts a portion of the transmitters and a portion of the receivers, and the back surface of the circuit board mounts a rest portion of the transmitters and a rest portion of the receivers.

8. The cable of claim 5
wherein the interface includes terminals and other terminals, the terminals being mounted on the top surface of the circuit board and electrically coupled with the portion of the transmitters and the portion of the receivers each mounted on the top surface of the circuit board, and the other terminals being mounted on the back surface of the circuit board and electrically coupled with the rest portion of the transmitters and the rest portion of the receivers each mounted on the back surface of the circuit board.

9. The cable of claim 4,
wherein the circuit unit is mounted only on one of the top surface and the back surface of the circuit board.

10. The cable of claim 9,
wherein the interface includes a portion of terminals mounted on the top surface of the circuit board and a rest portion of terminals mounted on the back surface of the circuit board,
wherein the portion of the terminals and the rest portion of the terminals are electrically coupled with the circuit unit mounted on one of the top surface and the back surface of the circuit board.

11. The cable of claim 4,
wherein the another interface includes a plurality of pads mounted on only one of a top surface and a back surface of the circuit board.

12. The cable of claim 4,
wherein the another interface includes a plurality of pads, a portion of which is mounted on a top surface of the circuit board, and a rest portion of which is mounted on a back surface of the circuit board.

13. The cable of claim 12,
wherein the top surface of the circuit board arranges the portion of the pads in respective sides to provide a space in a center thereof, and the back surface of the circuit board arranges the reset portion of the pads in respective sides to form a space in a center thereof.

14. The cable of claim 4,
wherein the connector includes a housing to enclose the circuit unit and the circuit board therein,
wherein the circuit board has a top surface and a back surface, the top surface forming a distance against an inner surface of the housing facing thereto greater than distance of the back surface against another inner surface of the housing facing the back surface.
